(19) United States
(12) Patent Application Publication
(10) Pub. No.: US 2018/0101806 A1
(43) Pub. Date: Apr. 12, 2018

(54) Quantitative Competency Management System for Learning Management System

(71) Applicant: Omolola Elizabeth Adepoju, Richmond, TX (US)

(72) Inventor: Omolola Elizabeth Adepoju, Richmond, TX (US)

(73) Assignee: Alpha Consults LLC, Richmond, TX (US)

(21) Appl. No.: 15/716,515

(22) Filed: Sep. 27, 2017

(51) Int. Cl. G06Q 10/06

(52) U.S. Cl. CPC G06Q 10/06395; G06Q 10/06393; G06Q 10/06398

(57) ABSTRACT

A method to objectively and quantitatively compute and assess the competency of an individual, client, employees or group of individuals in an organization using a learning management system is disclosed. The method describes how individualized and objective competency assessments map and competency gap map can be quantitatively generated using various proficiency attributes. Employees quantitative assessment are conducted based on attributes such as work experience, time of recent experience and other proficiency related attributes. The generated individualized competency assessment map is quantitatively compared to a pre-defined job function or disciplined based competency map for each competency category using variance analysis or other quantitative analysis to generate an individualized analysis of competency gap. This individualized competency gap can be rolled up to define the competency gap of an employee or a discipline in an organization, or the competency gap in the overall organization. The competency gap could be used by an organization to generate a learning plan which may be used to plan employee development programs or generate training plans. The organization competency gaps may also be used to plan for hiring, succession planning, promotions, management reports and assessing employee productivity. The learning plan can be used to track the competency or the proficiency of employees over a given period of time. This will allow the organization to track and determine growing proficiency of employees in the organization. The present invention also describes a method to conduct a competency health-check. The competency health-check allows the organization to ensure that her employees are up-to-date with the technology and knowledge in their profession. The disclosed method can be used as a standalone competency management system or used as a competency management system within a learning or content management system or such systems as a learning management system. The competency maps can be presented as a heat map, matrix, and a table or text report.

### FIELD OF INVENTION

The disclosure and description in this document relates to competency management system for a learning management system or learning management related system.

### BACKGROUND

Organization desires to hire, retain and have a productive work force. In order to have a productive workforce, the competencies of their employees have to be determined and managed. Each role in an organization has an attached competency requirement or skills to do the job effectively. There is always a need to ensure that the employee has the right skills to get the task done effectively. If there are competency gaps in an organization, the organization can require the employee to take training or assign employees new task that will allow them to master new skills. Most organizations are now subscribing to a learning management system (LMS). These LMS system is a software system that aggregates learning content, in particular e-learning and delivers this content to people while tracking the learner's progress. LMS systems can also be used as a competency management system or tool, as it can recommend courses to learners and it can report out the level of completion of the recommended courses. LMS systems can offer certificates at the end of course completions; this often after completing of a series of assessments and tests. Such method is described in U.S. Pat. No. 6587668 B1 to Miller et al., describing a corporate education system. In order for the LMS system to generate individualized learning plans it needs to assess the current competency of the learner or employees. Conventional LMS do not generate a customized learning plan to an individual, as all learners with similar job functions or similar work experience have similar recommended courses. These types of systems are not robust and results in waste as employees may be forced to take courses in areas that they are already proficient resulting in lost time and unnecessary cost to the organization. For a LMS to generate individualized and customized learning plan to learners it needs to objectively assess the competency of the learner.

Most employers assess the competency of their employees through surveys or assessment questionnaires filled in by the employee and sometimes endorsed by the supervisor of the employees. Such method is described in U.S. Pat. Application publication number 2002/0077884 A1 by Sketch. The current system is inherently biased as the subjectivity of the employee and his/her supervisor cannot be untangled from the process. An extroverted employee may rank himself as very proficient in a competency that he is a beginner and he may convince the supervisor to endorse his choice due to his personality. An introverted employee may under-play his/her skill set and may not want to draw attention to himself/herself. In both of these scenarios the organization obtains a flawed perspective of the competencies of her employees. Employees may also have different definitions of being proficient, resulting in 2 employees have the exact same experience self-assessing themselves differently.

This shows that there is a need to develop an unbiased, objective and quantitative competency assessment method to be used for competency management for the LMS system such that individualized and customized learning plan can be generated for each learner. The system can conduct a variance analysis of individualized competency assessment against standardized competency. The report from such a system can also be used to generate learning plans, career development plans, hiring plans, succession planning, promotions, and management reports on employee productivity. The described competency management system can also allow for competency tracking and competency health-check.

### SUMMARY OF THE INVENTION

The object of the present invention is to describe a system or method to assess the competency of an employee objectively and quantitatively. The method involves defining the competency required for each job function or discipline. The defined job function competencies are used to develop assessments, test questions or scenario based job simulations of actual job tasks. The competency for each job function is categorized as experiential proficiency and knowledge proficiency. Each proficiency category may have more than one attribute. Customizable weighting factors are given to the attributes under each proficiency category. The present invention obtains the experiential proficiency such as number of years of experience or recent years of experience from organization HR system database. The other attributes of knowledge proficiency is objectively accessed via assessment, test questions or scenario based job simulations. If the employee meets the pass criteria on the assessment, test questions or scenario based job simulations, the employees score is weighted and aggregated to determine his level of proficiency and competency in performing the defined tasks. The employee score in experiential and knowledge proficiency is weighted to determine an objective assessment of employee proficiency.

Another functionality of the present invention is that this objective and quantitative competency assessment can be implemented in a learning management system. In a preferred embodiment, an employee using a human-computer interface such as personal computer, laptops, tablets or mobile phones logs into a LMS that has series of e-learning courses or other courses. The employees role or job function and years of experience can be pre-populated into the LMS based on the employee unique ID. This unique ID can be used to query organization database which has relevant employee data. The experiential proficiency can thus be obtained from the employee information. Based on the employee job function, a series of assessments, test questions or scenario based job simulations are presented to the employee for all the attributes in the knowledge proficiency category. The scores of the employee from the assessments, test questions or scenario based job simulations are weighted and aggregated with the experiential proficiency score to determine the proficiency of the employee.

Another functionality of the present invention is that the generated objective and individualized competency assessment can be used to generate an individualized competency map that can be compared to the required competency map for the job function or discipline of the employee or learner. Variance analysis between the individual competency assessment and job function competency requirements results in an objective individualized competency gap.

Another functionality of this present invention is the objective generation of an individualized learning plan. The competency gap can then be used to develop a learning plan for the employee. The learning plan will contain action items that will close the competency gap of the employee and make the employee competent and proficient for the given job function or discipline. The learning plan will address gaps in the experiential proficiency such as need for more working experience and gaps in the knowledge proficiency such as courses, training, workshops and seminars that will give the employees the required knowledge to close the identified gaps. The learning plan could include courses or training on the learning management system or outside courses. The recommended courses from the learning plan will show up as required courses on the profile of the employee on the LMS. These recommended courses from the learning plan can also be visible to the organization representative (e.g. human resource personnel or employee supervisor) and the completion status of these courses can be tracked on the LMS.

Another functionality of this present invention is competency tracking. The progress of the employee in closing his/her competency gap can be tracked by tracking the status of the recommendations on the learning plan. In a preferred embodiment, the learning plan is tracked on a learning management system. The LMS gets updated with the completion status of each recommended course. A course status is updated when the employee takes the course and meets the pass criteria. The employee can take a course on the LMS or an external course outside the LMS to close the identified gap. In cases where courses are taken outside the LMS, certified completion certificates can be uploaded to the LMS. The numbers of years on the job can also be tracked by querying the organization database or by tracking the numbers of years in the current assignment. This information will be used to update the individualized learning plan and also for competency tracking.

Another functionality of the present invention is competency health-check. The world is in an information age and technology is continuously changing the way we conduct business. There is a need for an organization to ensure that her employees have the right and current competency based on the advancement in knowledge and technology. This invention describes a method where the assessment, test questions or scenario based job simulations that is used for competency assessment is constantly tested against the current skill set required to perform the job function or discipline proficiently. Additional questions may be added to the pool of questions in the assessment, test questions or scenario based job simulations if a gap is identified or a new skill is added. An employee competency health-check is conducted at certain interval periods by requiring employees to take the updated competency assessment, test questions or scenario based job simulations. The competency assessment, competency gap and learning plan of the employee are updated accordingly based on the performance of the employee on the assessment. The competency management system or method disclosed with this invention will ensure that the organization always have a plan to make her workforce proficient and up-to-date with the latest skills, knowledge and technology to get the job done efficiently.

### BRIEF DESCRIPTION OF THE SEVERAL VIEWS OF THE DIAGRAM

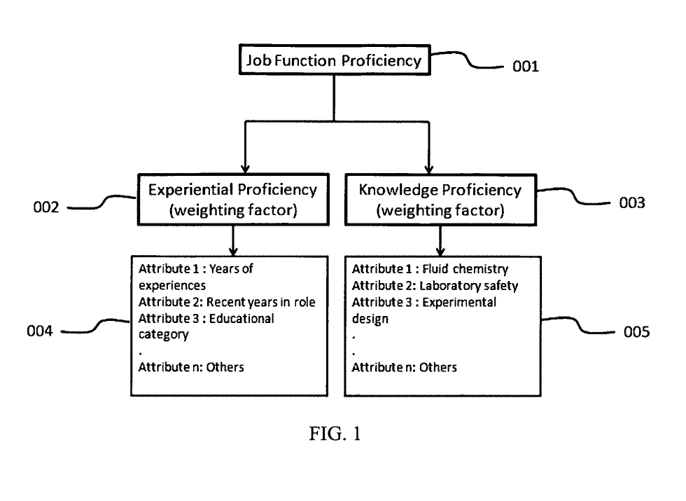

FIG. 1 is a flow diagram that illustrates the components of job function proficiency

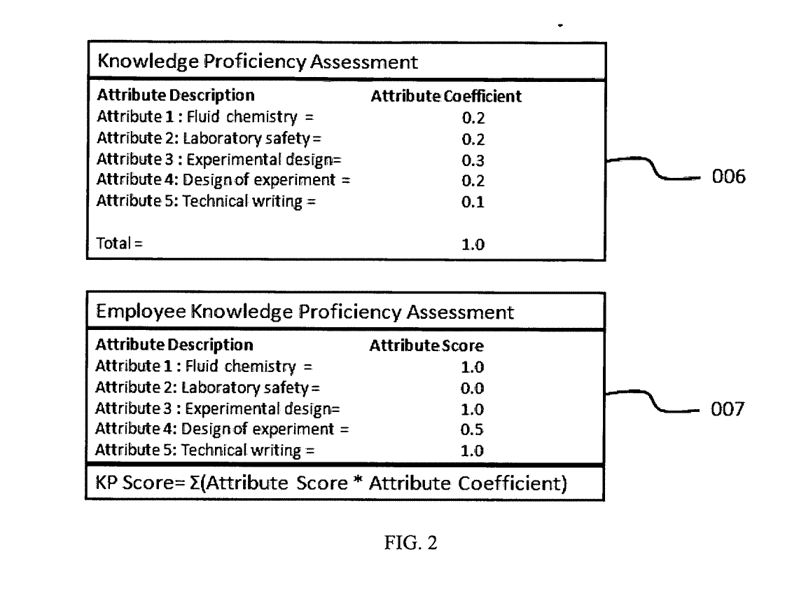

FIG. 2 is a block diagram that illustrates the attributes and components of knowledge proficiency

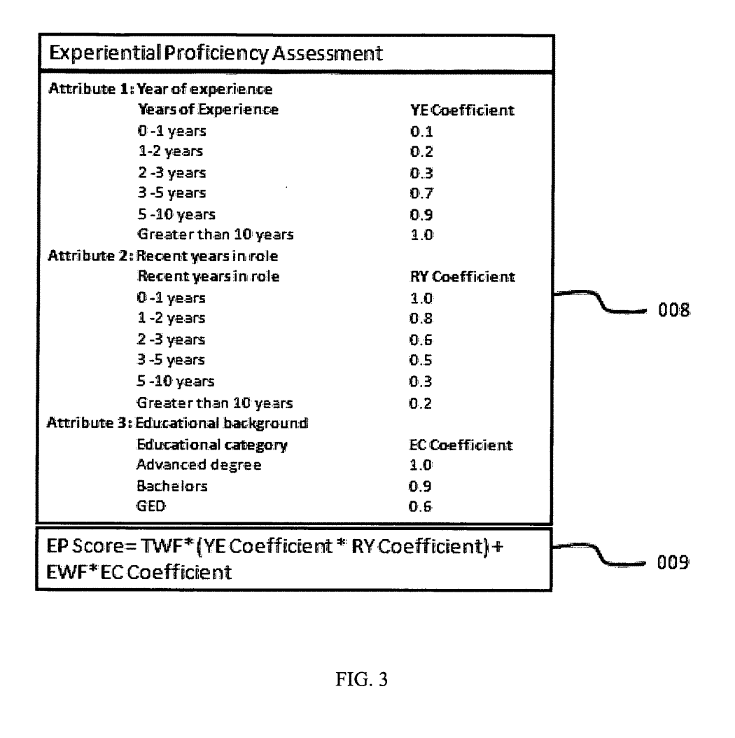

FIG. 3 is a block diagram that illustrates the attributes and components of experiential proficiency

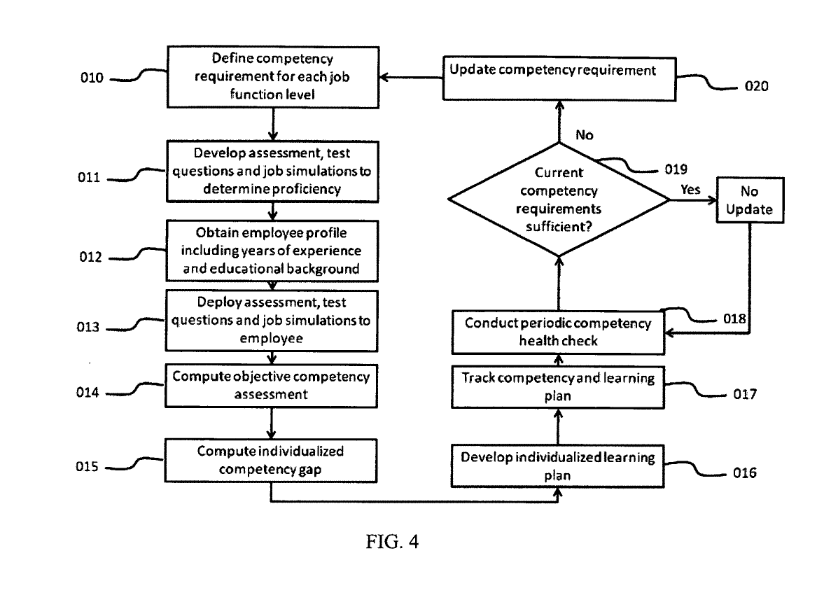

FIG. 4 is a flow chart for competency management

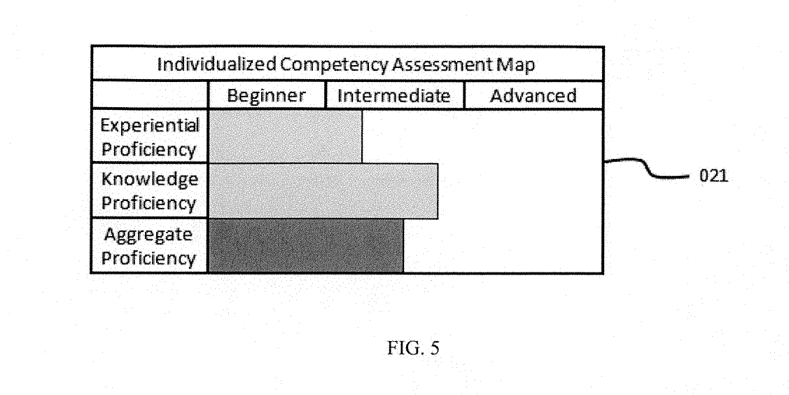

FIG. 5 is a block diagram illustrating individualized competency assessment map

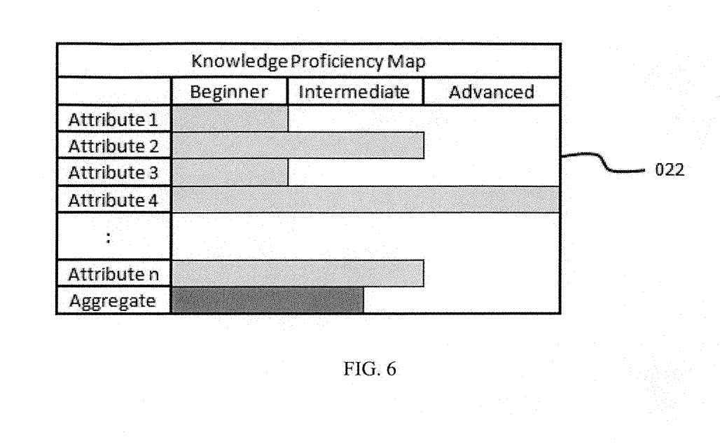

FIG. 6 is a block diagram illustrating knowledge assessment map

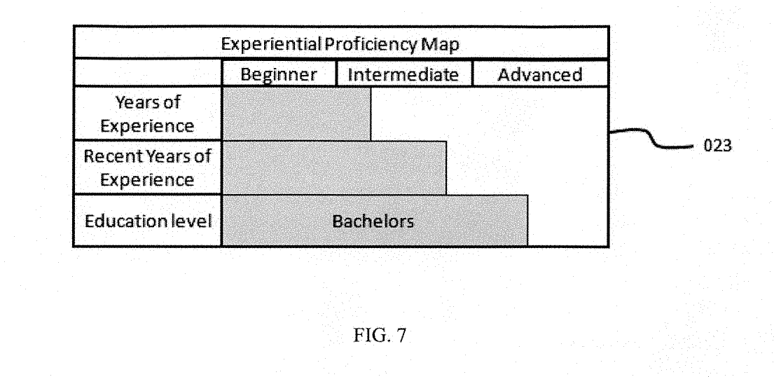

FIG. 7 is a block diagram illustrating experiential assessment map

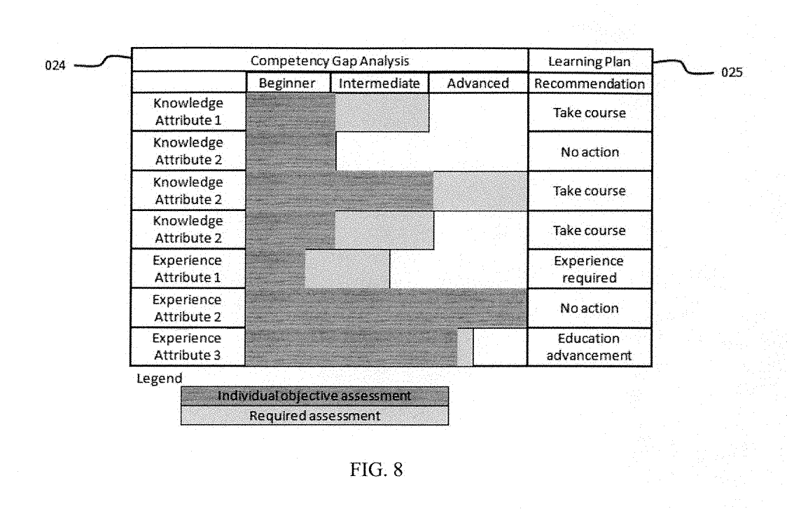

FIG. 8 is a block diagram illustrating competency gap analysis and recommended learning plan

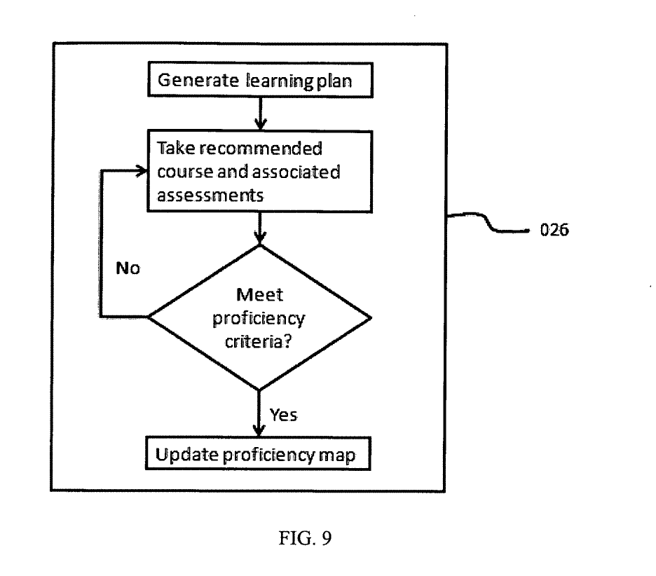

FIG. 9 is a flow chart for competency tracking

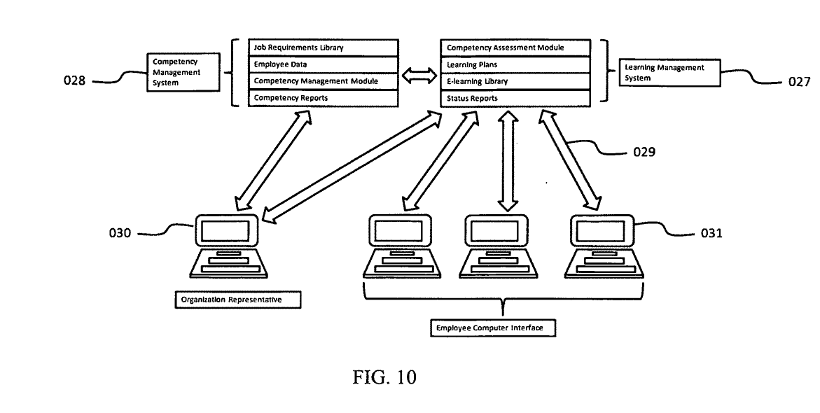

FIG. 10 is block diagram illustrating competency management and learning management system

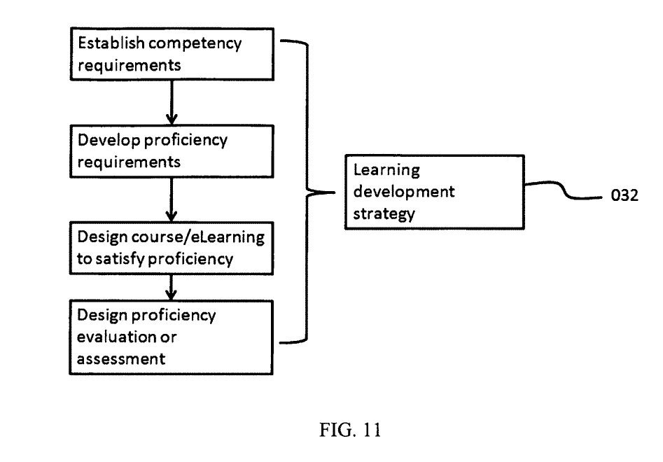

FIG. 11 is a flow chart for illustrating learning content development strategy

### DETAILED DESCRIPTION OF THE INVENTION

In a preferred embodiment, the competency requirements for a particular job function are described as shown in FIG. 1. The job proficiency for a particular job function is defined in block 001. The definition has to be unique for a given job position or employee role. In a preferred embodiment, an organization will have a library of job function proficiencies for all job positions in the organization. The competency requirements can be categorized as experiential and knowledge based proficiencies. Blocks 002 and 003 shows the associated experiential proficiency weighting factor (EPWF) and knowledge proficiency weighting factor (KPWF) for a given job function. The purpose of the weighting factor is to determine the relative importance of each category of proficiency to a given job functions. The weighting factor also helps to compute an objective proficiency score for an employee in a given job function. Each proficiency category can have a number of attributes that describes the proficiency category as shown in Blocks 004 and 005. The attributes of experiential proficiency category can include the years of experience and the level of education attainment. The knowledge proficiency attributes can include individual skill sets required to perform the job proficiently. An employee competency or proficiency score can be objectively computed with this formula: Proficiency Score=EPWF×Experiential Proficiency Score+KPWF×Knowledge Proficiency Score. In a preferred embodiment, EPWF and KPWF is a positive fraction that sum up to 1 (e.g. EPWF=0.6 and KPWF=0.4). The proficiency score ranges between 0 and 1 indicating no proficiency to completely proficient respectively. The proficiency score is used to generate the objective self assessment.

Block 006 shows the detailed description of the knowledge proficiency category. The attributes or skills required to perform a specific job competently and proficiency are described as attribute descriptions. The relative importance of each attribute is defined by the attribute coefficients. In a preferred embodiment, the attribute coefficients are fractions that add up to 1. Higher values of attribute coefficients are associated with the most important skill sets or attributes required to perform the job proficiently.

The knowledge proficiency score (KP Score) of an employee can be objectively computed using the illustration in block 007. Objective assessment that includes test questions and job based simulations are used to assess the level of employee proficiency for every attribute in the knowledge proficiency category. The proficiency of an employee can thus be objectively assessed to determine if the employee is considered to possess a beginner, intermediate or advanced level skill set for the job function. The employee is given an attribute score based on his performance on the assessment. In a preferred embodiment, a pass criteria for a beginner, intermediate and advanced level is established for each attribute. Employees that are at beginner level gets an attribute score of 0. Intermediate level and advanced level employees are assigned an attribute score of 0.5 and 1.0 respectively. The defined allocation of attribute score is preferable, but it is not the only way weighting factor or attribute score can be assigned. Block 007 also shows that preferably, the individual KP score can be objectively computed as the sum of the product of the attribute coefficient associated with the attribute and the employee attribute score. A KP score of 1 shows a complete proficiency while a KP score of 0 indicates that the employee as no knowledge proficiency.

In a preferred embodiment, an objective experiential proficiency score (EP score) can be computed as illustrated in block 009. The attributes of the experiential proficiency are shown in block 008. People that are familiar with the art could use a different combination of attributes to describe experiential or knowledge proficiency. The years of experience attribute is assigned years of experience (YE) coefficient to indicate the importance of years of experience to the specific job function. Preferably, YE coefficient will increase from 0 for no years of experience to 1.0 for sufficient on the job years of experience. Experiential years of experience can also account for recent years of experience. This is especially important for job functions in which the skill sets required for the job changes rapidly due to new innovation and technology. Preferably, employees that are currently working on the job function is given a recent year (RY) coefficient of 1.0, while employees years of experience are discounted by the number of years they have been away from the job. Education attainment can also be included in the EP score. The level of education required for a job function required for a job function can be assigned an education category (EC) coefficient. The relative importance of years of experience and education category to the specific job function can be described with the time period weighting factor (TPWF) and education weighting factor (EWF). In a preferred embodiment, TPWF and EWF are fractions that add up to 1. The formula for computing the EP score is shown in block 009. In a preferred embodiment, an EP score of 1 show an employee that meets the experiential proficiency for that given job function. In a preferred embodiment, a library of competency requirements is defined for each job function in the organization (block 010). The competency requirements for each job will detail the experiential and knowledge proficiency requirements and associated attribute for each proficiency category. The competency requirements are used to generate assessments, test questions and job simulations and case studies to determine the proficiency of an employee (block 11). In a preferred embodiment, the LMS can query the organizational database to obtain employee information such as education level and years of experience (block 12). The employees can also input their education level and years of experience into the LMS. The information will be verified by the supervisor or appropriate personnel in the organization. In a preferred embodiment, the developed assessment, test questions and job simulations are deployed to the employees via a LMS. Employee uses a computer interface (block 031) to assess the LMS (027) via a computer network system (block 029) to take required assessment for their respective job functions or job function of interest. The results from this assessment will be used to generate an objective competency assessment for the employee as illustrated in block 014. The objective assessment is based on the employee's competency score based on experiential and knowledge proficiency scores.

In a preferred embodiment, the employee competency can be visualized with an individual competency map as illustrated in block 021. Block 021 displays the employee competency with a block diagram. However employee competency can also be displayed as a pie chart or heat map or other visualization techniques. The employee competency map categorizes the employee proficiency as either a beginner, intermediate or advanced based on their KP and EP score. The aggregate proficiency can expressed by using the employee proficiency score, which is based on the employees KP and EP score. The organization will set the threshold score that will qualify the employee as a beginner, intermediate or advanced competency employee. Preferably, employees are categorized as beginner if their proficiency score range from 0 to 0.3, intermediate proficiency is between 0.3 and 0.6 and advanced skill level has proficiency level between 0.6 and 1.0.

In a preferred embodiment, the competency map can also be generated for each proficiency category as shown in blocks 022 and blocks 023. Block 022 visually illustrates the employee knowledge proficiency map by displaying the proficiency attribute score of the employee for each attribute in the proficiency category. The knowledge proficiency map also illustrates if the employee proficiency is considered as a beginner, intermediate or advanced level based on their attribute score. The employee KP score is used to determine the aggregate knowledge proficiency of the employee. Block 023 illustrates the employee experiential map by illustrating the score of the employee in each attribute in the experiential proficiency category.

The next step in the flow chart on FIG. 4 is to compute the individualized competency gap as illustrated in block 015. The competency gap analysis can be computed with a variance analysis between the employee proficiency score for each proficiency attributes and the actual job requirement proficiencies that was defined for the job function. In a preferred embodiment, the variance or delta score is computed using the formula: Delta score=Job attribute score−Individual attribute score. Delta score greater than zero indicates that the employee does not meet the target proficiency for that proficiency attribute. The individualized competency gap can be visualized with a competency gap map as illustrated in block 024. The employee attribute score and the required attribute score are plotted on the same bar to visually illustrate the competency gap of the employees. For people familiar with the art, other plotting methods may be employed to visualize the competency gap. Preferably, the competency gap map also indicates the level of proficiency of the employee be it a beginner, intermediate or advanced.

Preferably, the competency gap analysis will result in a series of recommendation for areas where the delta score is greater than 0. These recommendations are used to develop a learning plan for the employee as shown in block 016. The learning plan will help the employee to acquire the skills or experience required to be proficient in performing the job function. In a preferred embodiment, the learning plan is automatically captured in the LMS as illustrated in block 027. Block 025 illustrates a sample recommendation in a learning plan. The recommendation in a learning plan may be to close an experiential proficiency gap and in such cases employee may be recommended to continue performing a task or take advancement in education. The recommendation for knowledge proficiency is preferably to take a course to close the knowledge gap. In a preferred embodiment, an e-learning or online course library is already on the LMS that the employee can access as illustrated in block 027. Employee can also be recommended to take courses that may not be hosted on the LMS.

In a preferred embodiment, the competency and learning plan of the employee are tracked as illustrated in block 017. Preferably, the learning plan of the employee is tracked within the learning and competency management system. The number of years of the employee on the job is tracked and the completion of the recommended courses for the employees is also tracked as illustrated in block 026. The information is used to update the employee competency assessment map and the competency gap map.

A competency health check is also conducted as part of the objective competency management for the organization as illustrated in blocks 018 and 019. The world is in an information age and new technologies, skills and innovations are coming to the work place every day. The organization needs to periodically assess the completeness of the competency requirement of the job function in the light of the current skills required to do the job efficiently and competently. Preferably, the period can be every 12 months depending on how fast the skills required for the job evolves. As illustrated in block 019, the competency requirements for the job are updated if there is an identified gap in the job requirements. The new competency requirements will be used to generate updated assessment test questions to objectively determine the competency and proficiency of employees to perform the job functions effectively. In a preferred embodiment, the competency health check is also conducted for employees. Employees are required to take job assessment tests periodically. This is to ensure that the employees are up-to-date with the skills sets required to perform the job function effectively.

In a preferred embodiment, the organization has access to a competency management system (CMS) that is integrated to a LMS as illustrated in FIG. 11. Block 027 illustrates the LMS that contains the competency assessment module, where employee can assess the test questions for their various job functions or other job functions. The LMS also houses the learning plans such that the employees can assess the recommendations to close their competency gaps. Another component of the LMS is the e-learning library and the ability of the employee to take required courses for the library. The LMS tracks the competency of the employee and can generate status report. The organization representative can log into the LMS as well as the CMS. Preferably the CMS will house the job requirements and competency library and the employee information. The competency management module computes the competency assessment scores, computes competency gaps, generates competency maps, and generates learning plans and competency health check. The CMS can also be used to generate competency reports on an individual or organization basis based on the need of the organizations. The LMS and CMS are usually housed on servers maintained by the organization or third party organization.

In a preferred embodiment, the learning content in the LMS knowledge library is developed with a focus on the competency and proficiency requirements of the job function as illustrated on block 032. The competency requirements of the job function are translated to proficiency requirements. Proficiency requirements are actual skill sets that can be measured and acquired. A course, preferably an e-learning course is developed to satisfy the defined proficiency requirements. Appropriate tests questions and job based scenarios are developed to measure proficiency requirements. This learning content strategy ensures that the contents in the learning courses are targeted to the specific job function and not a repetition of the theory of the discipline.

The people who are familiar and skilled in the pertinent art of this invention will recognize the benefit and novelty of this invention. Though the preferred embodiment of this invention has been thoroughly described, people familiar with the art will recognize various modifications without deviating from the intent and scope of this invention which is defined with the following appended claims.

1. A process to objectively assess the competency of the employees in an organization, the process comprising:
defining measurable proficiency requirements or attributes of each job function;
classifying competency requirements into experiential and knowledge based proficiencies;
determining the relative importance of each competency requirements category with weighting factors;
determine the relative importance of each proficiency attribute in each competency requirement category with attribute coefficients;
developing objective test questions, assessment and task-based scenario simulations to assess the proficiency requirements for the job function;
assessing the proficiency of the employee by the performance of the employee on the assessment questions for each proficiency attributes; and
objectively determining the proficiency of employee by computing the employee experiential, knowledge and aggregate proficiency score.

2. A method to visualize the competency of an employee in an organization, the method comprising:
generating a competency assessment map for each proficiency category using proficiency scores;
generating a knowledge proficiency assessment map using the knowledge attribute scores;
generating an experiential proficiency assessment map using the experiential proficiency attribute map; and
generating competency gap assessment maps using the variance employee proficiency score and required proficiency score for each proficiency attribute.

3. A method of claim 1 additionally comprises process to develop individualized plans to achieve proficiency, the process comprising:
computing a delta score between employee proficiency score and job function proficiency;
recommending action items based proficiency attribute where employee proficiency score is lower than required job proficiency score or where delta score is greater than zero;
recommending courses as action items for gaps in knowledge proficiency attributes and recommending more experience or education in gaps in experiential proficiency attributes; and
collating all action items from assessed proficiency gaps into a learning plans that can be visualized and/or sent to a learning or competency management system.

4. A system for an objective competency management life cycle for an organization, the system comprising:
developing a library of job requirements and associated measurable proficiency attribute and coefficients for each job function in the organizations;
determining proficiency score for a beginner, intermediate and advanced level proficiency score for each proficiency and associated attributes;
determining the relative importance of each proficiency attribute for each job function by assigning weighting factors and attribute coefficient for each attribute and associated job functions;
generating assessment test questions that tests the proficiency of an employee for each proficiency attribute for the job function;
deploying assessment questions to employee to determine their competency for the job based on their performance in each proficiency attributes;
computing proficiency score for each proficiency category based on employee proficiency scores;
generating employee competency assessment based on computed proficiency score;
conducting employee competency gap analysis based variance analyzing between employee proficiency score and job function required proficiency score;
developing a learning plan based on employee competency gap assessment using proficiency score;
tracking the competency of employees by tracking the status of each recommendation on the learning plan and updating employee assessment and competency gap maps;
conducting periodic competency health check to ensure that the job requirements for each job functions are reflecting advances in technology and innovation; update the job competency requirements as needed; and
conducting periodic competency health check for employees by requiring them to periodically re-take assessment questions for their job functions.
